(19) United States
(12) Patent Application Publication
(10) Pub. No.: US 2012/0031498 A1
(43) Pub. Date: Feb. 9, 2012

(54) Water supply system and method

(76) Inventors: Aharon Carmel, Kibbutz Glil-Yam (IL); Moshe Katz, Zizaron Yakov (IL); Shay Popper, Kfar Yona (IL)

(21) Appl. No.: 12/808,681

(22) PCT Filed: Dec. 31, 2007
(86) PCT No.: PCT/IL07/01628

§ 371 Date: Mar. 10, 2011

(30) Foreign Application Priority Data
Dec. 17, 2007 (GB) 0724477.5

(51) Int. Cl. F15D 1/00; F16K 31/02

(52) U.S. Cl. 137/2; 137/565.01; 137/487.5

(57) ABSTRACT

A system for supplying hot and cold water to an apartment/house. Recycling water from the hot into the cold water pipe comprises a faucet having adjustable first and second valves installed in the paths to hot and cold water inlets and third valve in the path to outlet. The valves are electrically controlled; circulating pump installed in the cold water pipe. When the first and second valves of at least one faucet are open and the third valve closed, activating the circulating pump will cause water from the hot water pipe to flow through the faucet to the cold water pipe; c. controller means for activating the three valves and the circulating pump in one of two modes of operation: in a first (circulation) mode, water circulation is accomplished by opening the first and second valves and closing the third valve.

The present invention is related to, and claims priority from, patent application No. GB0724477.5 filed by the present applicant in Great Britain on 17 Dec. 2007.

### FIELD OF THE INVENTION

The present invention relates to a system and method for supplying hot and cold water for domestic, commercial or industrial use, and more specifically for such a system including means for saving on the use of water and energy.

### BACKGROUND OF THE INVENTION

In a domestic, commercial or industrial environment, there are hot and cold water pipes supplying water to the various users or faucets there.

A problem in such prior art systems is the waste of water while waiting for the hot water to arrive. This water is wasting away. The waste is estimated at about 10 liters (about 2.2 British gallons). If water is temporarily turned off, it may take time and some adjustments to later regain the water supply at the desired flow rate and temperature. To avoid bothering with these burdens, people taking a shower often leave the water running for the whole duration, thus wasting water unnecessarily.

Despite such precautions, variations in water temperature do occur, due to changes in water pressure and use of water by other users in the house, depletion of hot water in the water tank, etc.

Another problem in prior art water supply systems relates to water freezing in the pipes in cold weather. This may cause a stoppage in the water supply, as the ice thus formed prevents water from flowing in the pipe. Moreover, the extreme forces related to water freezing can damage the pipe.

Popper et al., U.S. Pat. No. 6,895,985—Smart device and system for improved domestic use and saving of water, presents a system for providing a user with water at a desired temperature, using means to allow circulation of the hot water into the cold water pipe. Thus, while waiting for the hot water to arrive at the faucet, the water from the hot water pipe is circulated onto the cold water pipe.

Still, various problems remain, which are solved with the present disclosure, which also presents improvements in Popper.

### SUMMARY OF THE INVENTION

The present invention is described generally with reference to the following innovative aspects:

1. A system for supplying hot water to an apartment/house, to all or part of the users, while recycling water from the hot water pipe into the cold water pipe. The system may also be used in commercial or industrial establishments.
2. A method for supplying hot water, while managing micro valves in the faucet, water circulation and/or heating in the water tank.
Automatic water circulation may also be used to prevent water from freezing in the pipes.
3. A new micro valve including three valves activated electronically, and easily installable in standard diameter faucets
4. Human-machine interface, using effective means for allowing the user to control the water temperature and flow rate, as well as various additional parameters.
5. A device for mixing fluids from a plurality of sources. For example, people may desire to use either potable water or sea water, then to mix hot and cold water. Various materials may also be mixed.
6. Protecting users from burns due to exposure to hot water—New safety standards demand to limit the temperature of the hot water supply, to protect users from accidental burns if exposed to hot water only, for example Israeli standard No. 5463 and Australian standard No. 4032.2. The temperature of hot water supply should be limited to a predetermined value, for example 45 degrees Celsius.
7. Operating panel with advanced display means, including for example VGA or video or television display for viewing TV or movies or other info while in the shower.
A multi-functional display may be used both to control the water supply and subsequently to present other information.

### BRIEF DESCRIPTION OF THE DRAWINGS

FIG. 1 illustrates a prior art system for supplying hot and cold water

FIG. 2 illustrates a system for saving water by circulating hot water into the cold water pipe

FIG. 3 illustrates a multi-faucet distributed system for saving water by circulating hot water into the cold water pipe

FIG. 4 illustrates a multi-faucet centralized system for saving water by circulating hot water into the cold water pipe

FIG. 5 illustrates the propagation of hot water front toward the faucet in the circulation mode of operation

FIG. 6 details a method of operation of the system

FIG. 7 illustrates the water temperature at the faucet during the circulation stage

FIG. 8 details the water circulation stopping process

FIG. 9 illustrates one embodiment of a faucet

FIG. 10 illustrates two cross-sectional longitudinal views of another embodiment of the new faucet

FIG. 11 details a new valve structure

FIG. 12 illustrates a functional cross-sectional view of a preferred embodiment of the new micro valve, detailing the cold and hot water inlets

FIG. 13 illustrates a functional cross-sectional view of a device for mixing fluids from a plurality of sources

FIG. 14 illustrates two cross-sectional longitudinal views of yet another embodiment of the new valve

FIG. 15 illustrates a top view of the faucet

FIG. 16 illustrates one embodiment of a human-machine interface

FIG. 17 illustrates another embodiment of a control panel

FIG. 18 illustrates yet another embodiment of the control panel

FIG. 19 illustrates yet another embodiment of the control panel

FIG. 20 illustrates a system for delivering hot water at a safe temperature.

FIG. 21 details another embodiment of a new valve structure

### DETAILED DESCRIPTION OF THE PREFERRED EMBODIMENTS

The description generally details the seven innovative aspects of the invention, although the various aspects of the invention are interrelated in one innovative concept.

### 1. System for Supplying Hot and Cold Water to Users in a Domestic, Commercial or Industrial Establishment

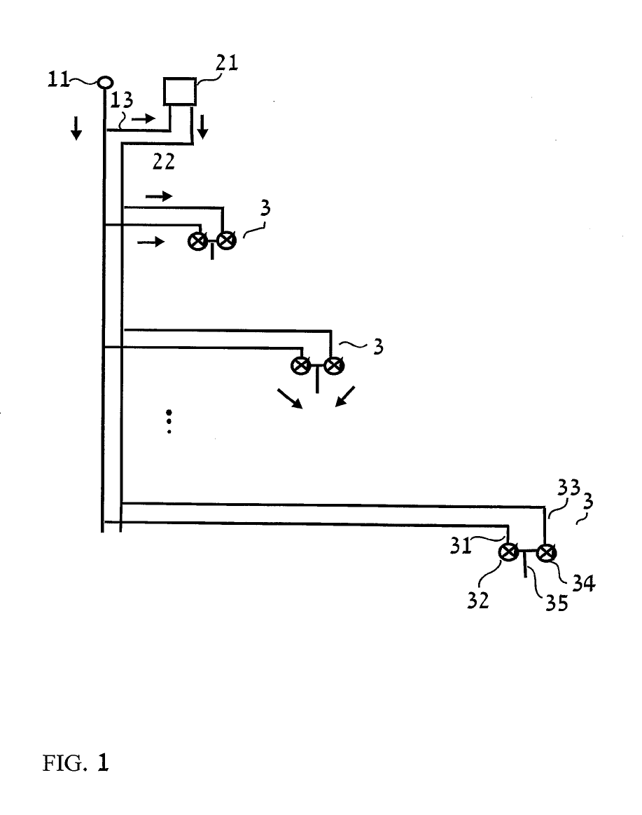

FIG. 1 presents a functional description of a prior art system for supplying hot and cold water.

Water from a water supply inlet to the house 11 is supplied as cold water, through a cold water supply pipe 12 and its ramifications, to all the users in the house.

There is also cold water supply through pipe 13 for the hot water subsystem, using the water tank 21 to heat the water. The hot water is supplied to users in the house through hot water supply pipe 22 and its ramifications.

The present invention may be used where there is no water tank 21, for example using an in-line heater, such as manufactured by Atmor Ltd.

Various water heating means may be used, for example using solar energy, gas heating, etc.

Each user may have a hot/cold water faucet 3.

At the faucet 3, there is a cold water inlet 31 with a cold water valve 32 controlling the supply of cold water, and a hot water inlet 33 with a hot water valve 34. Water is supplied to users through a water outlet 35. Usually, the valves 32 and 34 are mechanically controlled by the user.

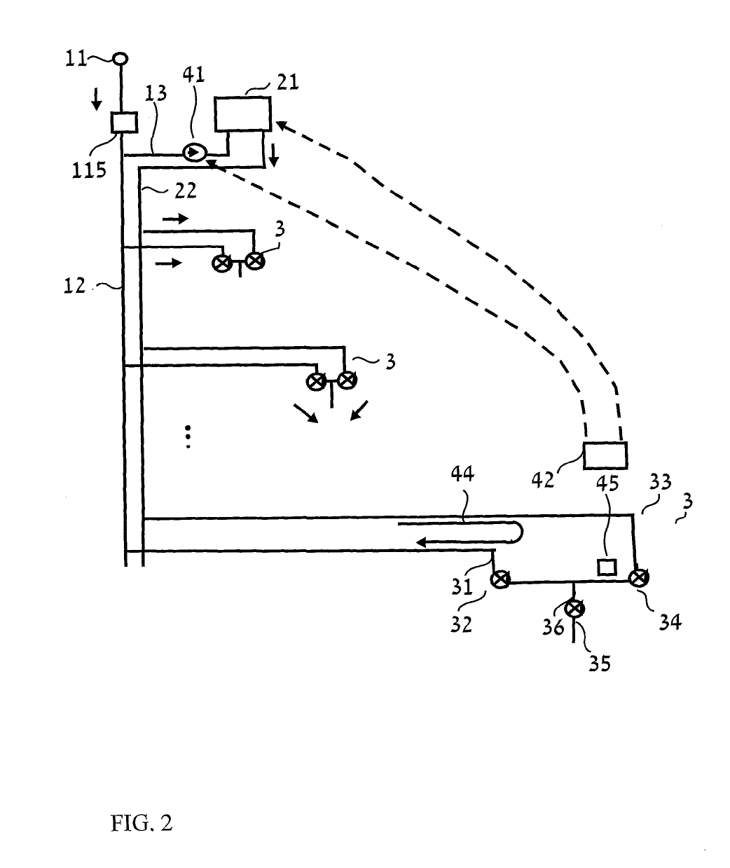

FIG. 2 illustrates a system for saving water by circulating water from the hot water pipe into the cold water pipe.

In this embodiment, the valves 32, 34 and 36 are electrically controlled. The new faucet has also an outlet valve 36. When valve 36 is closed and both valves 32, 34 are open, then circulation is possible, wherein water from the hot water pipe can flow into the cold water pipe.

A circulating pump 41 pushes water along the closed circuit comprising the water tank 21, hot water supply pipe 22, valves 34 and 32, cold water supply pipe 12, pump 41 and back to the tank 21. See direction of circulation water flow 44.

A unidirectional valve 115 may be installed at the mains supply entrance to the house. The valve allows water to flow into the house water system, but prevents water from flowing back out of the house. If such a valve is installed, suitable means for releasing excess water pressure should be provided (otherwise expanding water may exert a very large pressure, which may cause damage to the installation).

A temperature sensor 452 measures the water temperature in the faucet, in case only one temperature sensor is used. Preferably sensor 452 is located in the mixing chamber in the faucet, to measure the temperature of the output water.

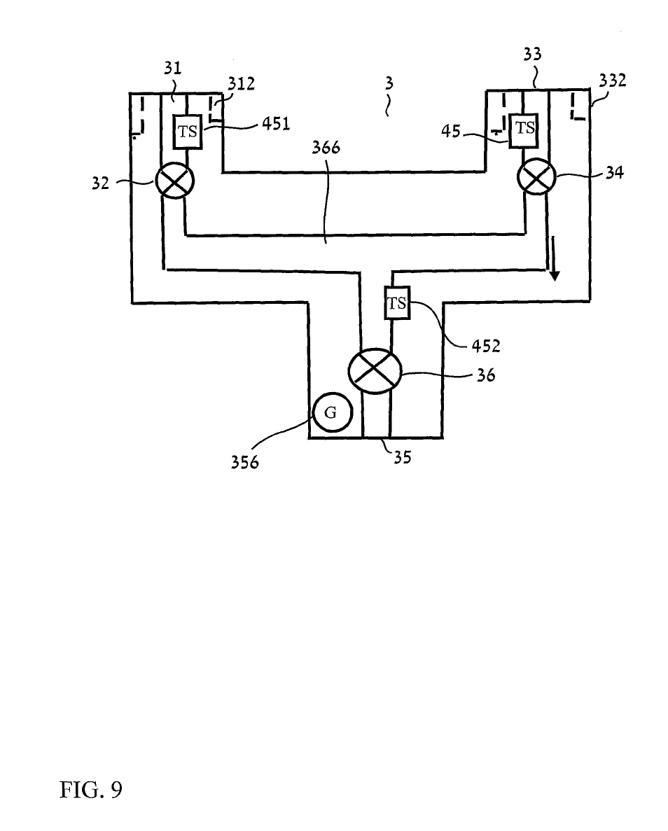

If one temperature sensor is used in the system—this is the output sensor 452 (FIG. 9), at the output of the faucet or in the mixing chamber. If two sensors are used, then the second sensor is that at the hot water inlet, sensor 45; If three sensors are used, then the third sensor is the temperature sensor 451 at the cold water inlet.

Using more than one sensor allows the controller to measure the temperature of hot and cold water supplied to the faucet, in addition to the temperature of the output (supplied) water. This info may be advantageously used by the control algorithm.

For controlling the temperature of the delivered water, only one sensor in the mixing chamber is enough. This is the preferred embodiment where a cost effective solution is desired.

In a preferred embodiment, the software calculates a temperature gradient vs. time, also using the rate of flow, to better control the supply of water, to achieve a regulated supply of controlled temperature and flow rate.

The faucet control unit 42 controls the operation of the valves 32, 34, 36 and the circulation pump 41.

Optionally, it also controls the hot water tank 21, to heat the water when necessary.

The circulating pump 41 is preferably mounted in the cold water pipe 13, so it will not have to endure high operating temperatures as may be expected in the hot water pipe 22.

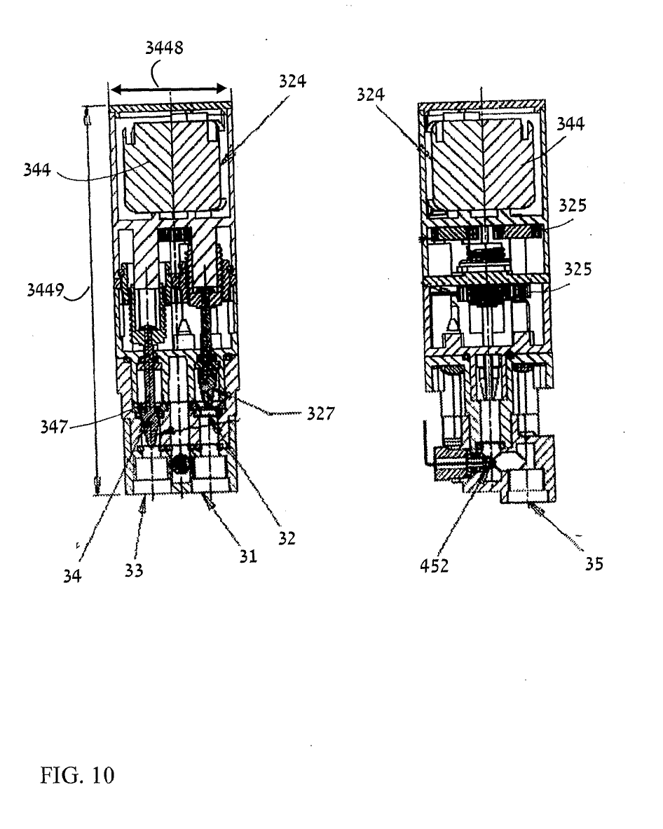

In a preferred embodiment, where only one temperature sensor is used, then it is the sensor 452 in the mixing chamber, see FIG. 10.

In another preferred embodiment, the only temperature sensor being used is the sensor 452 at the output 35 of the faucet (at the water supply to user), see FIG. 9.

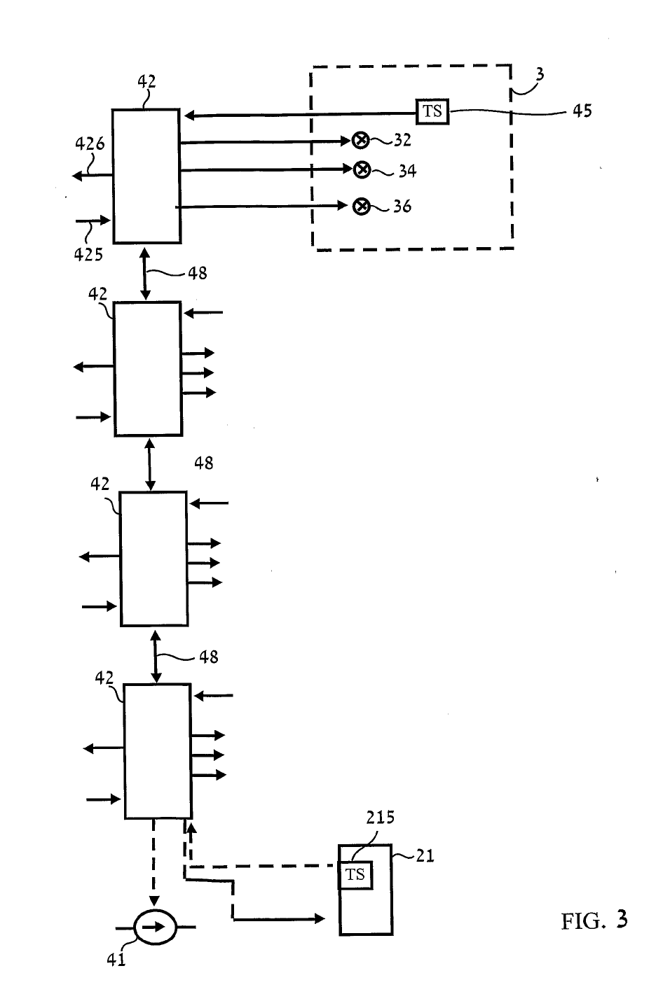

FIG. 3 illustrates a multi-faucet distributed system for saving water by circulating hot water into the cold water pipe.

There are faucet control units 42, each controls the operation of valves 32, 34, 36 for one faucet 3.

The operation of the faucet is according to input commands from user 425. The unit further includes display means 426 for presenting information to the user regarding the water temperature and other parameters. Other indicator means may be used in lieu of or in addition to the display means 426, for example audio indicator means.

In this distributed system, a request to activate the circulation pump 41 is transferred to another unit 42 through a communication channel 48, the process is repeated until the request reaches one of the units 42 which actually controls the pump 41 and optionally the heating in the tank 21, responsive to hot water requests from all the units 42.

Preferably, each controller in a faucet has the capability to communicate with other such units and to control the pump 41 and the heating unit in the tank 21.

The controlled in each faucet may include bi-directional communication links with other faucets, to transfer commands and status info between the units. The controller may use existing integrated circuit controllers which connect to each other automatically, recognize the topology of a network and transfer information between the nodes of the network.

The communication channel 48 may be implemented using radio frequency (RF) communications, wired links, ultrasound, infrared and/or other communication means.

The water temperature in the tank 21 may be measured using a temperature sensor 215 (or several sensors) mounted there. The result may be transferred to a unit 42, and from it—to the rest of the units 42.

The info regarding the tank water temperature may be used in the control method/algorithm to better control the circulation and the supply of hot water to the users.

Optional: the water temperature may be displayed on the faucet display.

For example: When the temperature of hot water is high, a lower circulation speed may be used, so the faucet will not be suddenly awash in very hot water. When the hot water temperature drops below a threshold, heating may be activated. The threshold may depend on expected hot water use: if a heavy usage is expected, the water may be kept at a higher temperature.

There may be variations in water temperature in the tank; using readings from several sensors, a better estimate of the total quantity of hot water is achieved. For example, the average of the various readings may be computed, or a weighed average, to assign the correct importance to each sensor.

It is possible to install a plurality of temperature sensors in the tank, for example at the top, middle and bottom of the tank. Other means may be used to measure the temperature of water in the tank, for example water circulation in the tank.

A plurality of such sensors may better evaluate the remaining hot water in the tank, to warn of an imminent shortage of hot water.

In another embodiment, readings from only one temperature sensor vs time may be used, with a suitable method/algorithm, to evaluate the remaining hot water in the tank and to warn of an imminent shortage of hot water.

Optionally, the units 42 also control the hot water tank 21, to heat the water when necessary.

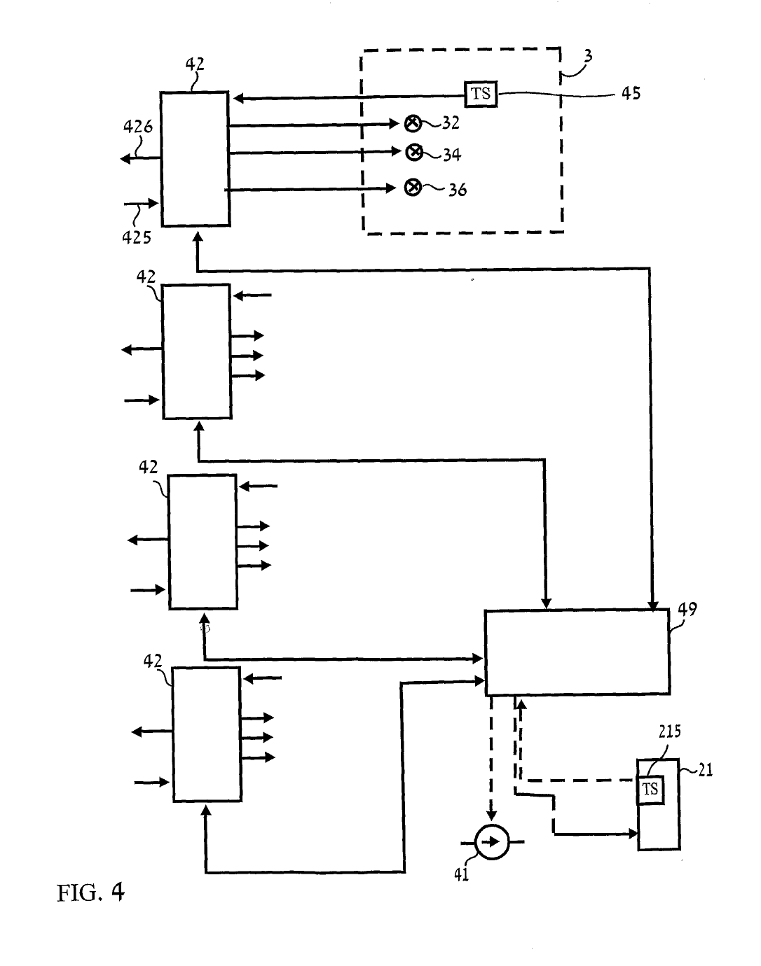

FIG. 4 illustrates a multi-faucet centralized system for saving water by circulating hot water into the cold water pipe.

The faucet control units 42, each controls the operation of valves 32, 34, 36 for one faucet 3.

There is a channel for input commands from user 425, and display means 426.

In this embodiment, there are three temperature sensors 45, 451 and 452 (see FIG. 9) attached to the hot water inlet 33, cold water inlet 31 and water outlet 35, respectively.

It is important for the sensor 452 to have a fast response and measure the temperature in the water.

A request to activate the circulation pump 41, from the unit 42, is transferred to a central computer 49.

Other units 42 can also transfer their requests to the computer 49.

The computer 49 controls the pump 41 and optionally the heating in the tank 21, responsive to hot water requests from all the units 42.

The water temperature in the tank 21 may be measured using a temperature sensor 215 (or a plurality of sensors) and an optional prediction algorithm. The result is transferred to the computer 49 for better control of the system.

The prediction algorithm/method may use temperature readings as a function of time, and information about the rate of flow of water, to estimate the temperature of water in the tank and/or the amount of available hot water.

Optionally, the computer 49 also controls the hot water tank 21, to heat the water when necessary.

2. Method for Supplying Hot Water, while Managing Micro Valves and/or Water Circulation

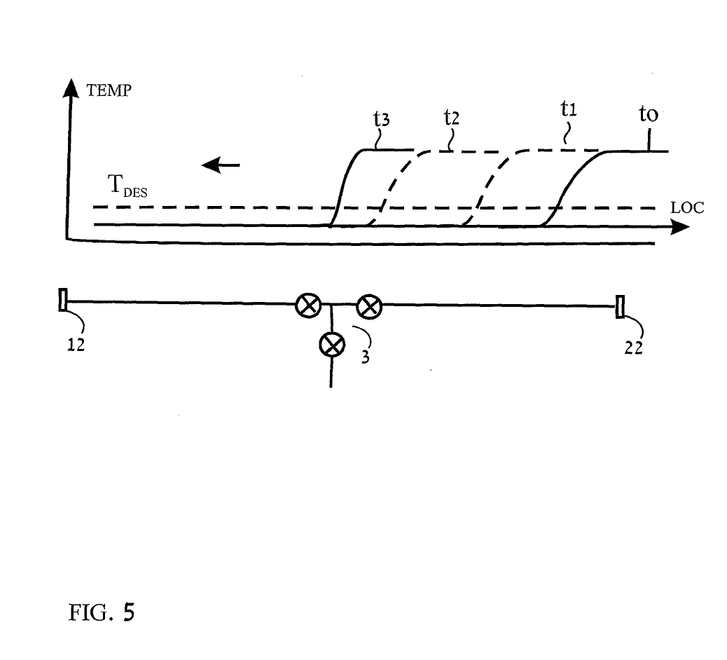

FIG. 5 illustrates the propagation of hot water front toward the faucet in the circulation mode of operation, in a time-location graph, for various values of the Time parameter.

Initially, at time to, the water throughout the pipes is at a low temperature (the ambient temperature); only the water near the hot pipe 22 are hot.

When the circulation is activated, a hot water front advances toward the faucet 3 and the cold water pipe 12, as illustrated with temperature profiles at consecutive time periods t0, t1, t2, t3 . . . .

At time t5, the hot wave arrives at the faucet, with the temperature of the water there being just the desired temperature Tdes. Circulation is stopped at that moment, and water can be supplied to the user.

### Method of Operation to Supply Hot Water to User

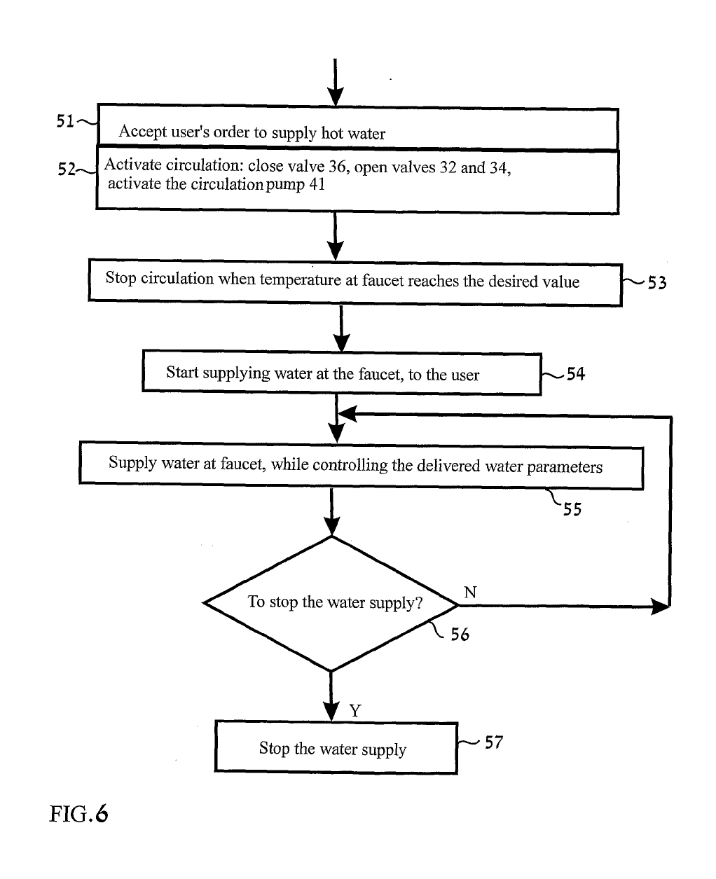

FIG. 6 details a method of operation of the system, including:

1. accept user's order to supply hot water 51
2. activate circulation: close valve 36, open valves 32 and 34, activate the circulation pump 41 52
3. stop circulation when temperature at faucet reaches the desired value 53
4. start supplying water at the faucet, to the user 54

Water supply starts either when ready, or only after a prompt from the user, see notes below.

5. supply water at faucet, while controlling the delivered water parameters 55
6. Check: to stop the water supply? 56 if not—goto (5)
There may be various criteria for stopping the water supply, see notes below.
7. stop the water supply 57
**End of method**

### Notes

1. There are three possible embodiments for starting to supply water to the user in the above method, step (4):
a. As soon as water at the desired temperature is available at the faucet, the system will start the water flow out of the faucet, to the user;
b. When water is available at the desired temperature, the system will activate a READY indicator; the user may press a button to start the water supply when so desired. The READY indicator may be visual, audible or using other means.
c. Water now—the system performs circulation all the time, or intermittently as the need be, to keep hot water close at hand at the faucet. When the user requires hot water, the system may respond immediately.

If there are several faucets requiring immediate response, then the system may perform circulation to bring hot water to the first faucet, then circulation to bring hot water to the second, third, etc.

When the system senses (using temperature sensors) that the water at some faucet gets cold, circulation is again initiated to bring hot water to that faucet, by opening the first and second valves there.

2. The faucet may have one of the methods in (1) embodied therein, or the method may be programmed by the user—one user may prefer to activate the water supply as soon as possible, another may prefer to activate it at the right time.
3. There are various criteria for deciding when to stop the water supply in step (6), for example:
a. The system detects the hot water supply is expected to be depleted soon therefore the desired temperature cannot be maintained for long; a suitable indication is issued, to warn the user to hurry and finish before water gets cold. Preferably, the system may include a display to indicate the time remaining for washing, using a countdown method for example:
   9 minutes to finish, 8 minutes, 7, 6 . . . .

In time, the system learns the characteristics of water supply and use, and may use the measured time variables to estimate the remaining hot water supply.
b. The water is stopped immediately when the user so commands the system.
c. Pre-programmed mode—the system is programmed in advance to supply water for a predefined time period. When the time period ends, the water is closed. Preferably, a warning is given to user that the water will be shut up. The warning may precede the action by a predefined time interval, for example one minute, 5 minutes, etc.
d. any combination of the above (a to c).

This mode may be practical for hotels or where there is a water shortage and it is required to save on water. This mode is optional and should be used with caution, so as not to irritate customers by its application when not really necessary or justified.

4. In a preferred embodiment, when there is circulation, then all the users are shut off—there is no water supply to any user. Water supply to users only commences when circulation stops.
5. Close the water supply if the temperature is too high, to protect the user from possible injury.
Method for Preventing Water from Freezing in Pipes

The method may use the system with water temperature measurement and water circulation as detailed in the present disclosure, in its various structures.

Additional temperature sensors may be installed in the water pipes in locations prone to freezing, these being connected to controller means or other automatic decision means. The method includes:

1. Measuring the water temperature in a plurality of locations in the water pipes of a domestic, industrial or commercial establishment. The temperature readings are transferred to a controller, computer or other automatic decision means.
2. If there is an imminent danger of water freezing apparent in the temperature readings from a specific location, water circulation is activated in that specific location.

Optionally, heating is also applied. Often, just causing a movement in the water will suffice to prevent from freezing, even if the temperature is close to freezing point. Automatic water circulation means may also be used responsive to a low water temperature or to a dangerous rate of descent of the temperature, to prevent water from freezing in the pipes.

The water circulation may be applied selectively, to locations prone to freezing, for example using the valves as detailed in this application to form a water circulation loop while preventing water from flowing out.

**End of method**

Note: This is also a novel system feature: the system structure as detailed in this disclosure, with additional temperature sensors being installed in the water pipes in locations prone to freezing, with the additional proviso that these locations are within the domestic water system, that is a circulation pump can be activated to circulate the water in these locations. Additional water loops may be created in difficult locations, k as will be apparent to a person skilled in the art. This structure allows to fight/prevent water freezing using circulation in the pipes.

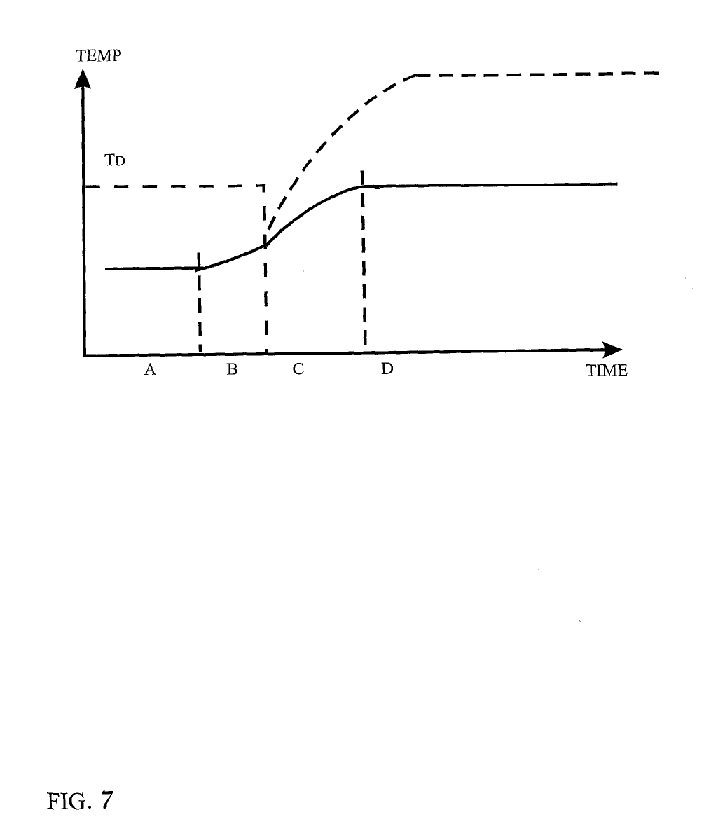

FIG. 7 illustrates the water temperature at the faucet during the circulation stage:

stage A—water temperature is that of cold water, the hot water front did not arrive at the faucet yet
stage B—water temperature is rising
stage C—circulation is slowed down or stopped, temperature is rising at a slower rate
stage D—circulation stopped, water delivery at constant temperature to user

This shows the importance of stopping the circulation on time, so as not to exceed the desired temperature.

### Method for Stopping the Water Circulation

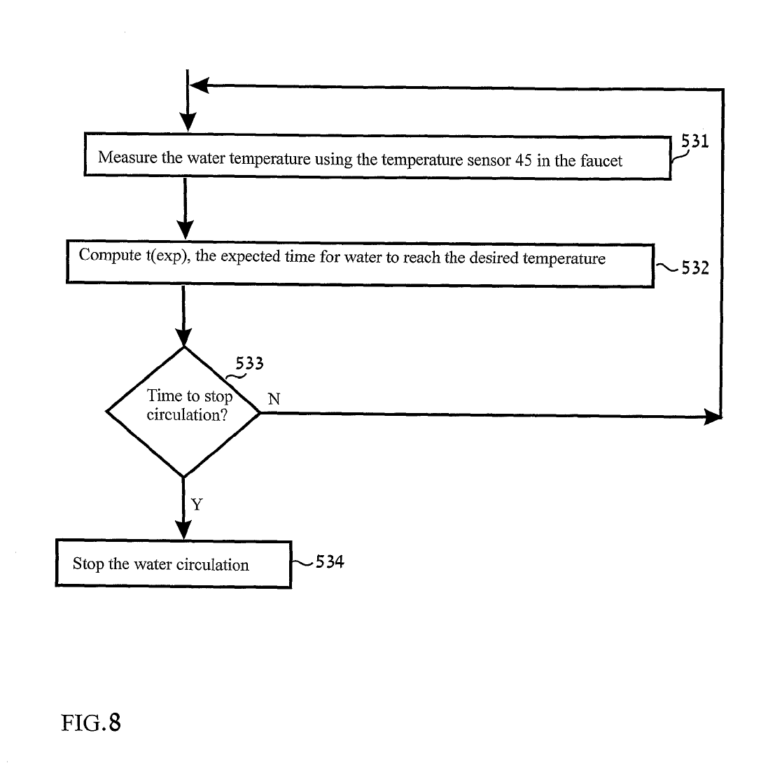

FIG. 8 details the water circulation stopping process, comprising:

1. measure the water temperature 531 using the temperature sensor 45 in the faucet if two temperature sensors are used in the faucet (one at the hot water inlet, the other at the cold water inlet), then their readings may be advantageously used to better measure the temperature gradient in time and space.

The system may display the time remaining until water is ready and available to the user, for example based on prior experience. The system may measure the time required until hot water arrive to each faucet. When a user requires hot water, this value may be presented.

2. compute t(exp), the expected time for water to reach the desired 532 temperature. In a first embodiment, first order estimation: compute the rate of temperature change over time, dT/dt=delta(Temperature)/delta(time)—this is the slope of the graph T=f(time) in FIG. 5.

In other embodiments, higher derivatives of the T=f(time) function may also be used. This may achieve better performance, since the graph T=f(time) may not be linear.

3. time to stop circulation? 533

In a simple embodiment, check whether water at faucet reached the desired temperature, then it is time to stop the circulation.

In a more advanced embodiment, there is a parameter in the system, t(stop)=the time required to stop the water circulation, taking into consideration the inertia of the moving (flowing) mass of water and the response time of the circulation pump and the valves.

When the Expected time t(exp) equals the stopping time t(stop), it is time to stop the circulation.

the goal is to stop the circulation in time, so that the water temperature at the faucet 3 will not exceed the desired temperature.

4. stop the water circulation 534

Preferably, the circulation is stopped abruptly, to allow the use of a simple, low cost circulation pump and simple control means. A simple ON/OFF control is used.

In another embodiment, the circulation is not stopped abruptly, as this may cause excess pressure in the pipes and on the system components. If necessary, the circulation pump and/or the circulation valves 32, 34 are so activated as to gradually stop the circulation, at a desired rate according to engineering considerations.

Another consideration is the temperature rate of change, dT/dt. If the rate is high, stopping the circulation suddenly may cause an error in the faucet temperature—a small error or variation in the timing causes a large error in temperature. Gradually slowing down the rate of circulation gives better control over the final water temperature at the faucet when the circulation stops. Preferably, the system uses a circulation pump 41 of a type which allows water to flow therethrough when the pump is not activated.

This is an important functional and engineering consideration, as it will allow cold water to flow into the tank and thence to supply hot water even when the pump is not activated—the system working in the usual way. This is the mode of operation after hot water reaches the faucet and circulation is no longer necessary.

One preferred embodiment for the circulation pump 41 is a centrifugal pump.

### Method for Stopping the Circulation

a. The circulation pump 41 is deactivated
b. after a time delay—close the valves 32 and 34 to gradually stop the water circulation. In another embodiment, it may be desirable to optimize the use of energy (to save energy). In this case, valves activation (opening and closing valves) is minimized. For example, to stop circulation—stop the circulating pump and wait for water to stop moving, without changing the settings of the valves.

Then set the valves to the desired setting to supply water to the outlet, at the desired flow and temperature as in (c). The point is not to close the valves, in order to save energy.

c. after a time delay—adjust the valves 32 and 34 to the desired output flow and temperature
d. open the output valve 36, only after the valves 32 and 34 settle at their desired settings and (optionally) after the user approves to open the water supply.
**End of method**

In another embodiment of the Method, circulation is stopped by deactivating the pump 41; the valves 32 and 34 are then directly set to the desired output flow and temperature, skipping the step (b) of closing them.

In a preferred embodiment, valves 32 and 34 can be continuously adjusted, whereas valve 36 is ON/OFF (ON to supply water to user, OFF for water circulation). In another preferred embodiment, valves 32 and 34 are adjusted almost continuously, that is in fine steps, using a stepper motor for each valve, for example.

Method for Taking into Account Prior Orders and Also Occasional Users

The method comprises:

a. taking orders, learning habits of use of hot water
b. activating the heater in the hot water tank to heat the water as required (optional). Various means may be used to heat the water: solar energy, gas, electricity or a combination thereof.
c. hot water supply, stage 1—preparation
opening circulation valves in the faucet and then activating the circulation pump, where desired
stopping the circulation
Optional: activating a READY indicator, when hot water at the desired temperature are available for immediate use.
   d. hot water supply, stage 2—delivery
adjusting circulation valves to required rate of outflow and temperature
opening the output valve
continuous, automatic adjustment of the valves to keep flow at desired rate and temperature, despite disturbances in the system—changes in water pressure, use of water by other customers, changes in hot/cold water temperature, etc.
changing flow parameters as requested by customer: flow rate, temperature
stopping the water delivery (closing the faucet). optionally, a display or an audio warning may be presented before water supply begins.
   **End of method**

### 3. New Micro Valve

FIG. 9 illustrates one embodiment of a faucet 3.

The control unit (not shown) is connected to, and controls the operation of, the cold water valve 32, hot water valve 34 and output water valve 36.

The control unit also receives signals indicative of the measured temperature from the temperature sensors 45, 451 and 452.

Preferably, the sensor 45 is immersed in water, to achieve a fast response and to measure the temperature in the water, preferably the incoming hot water; a sensor mounted in the structure of the faucet itself may not be satisfactory, as it may have a time delay in the measurement.

The other sensors 451, 452 may also be immersed in water.

The cold water inlet 31 and hot water inlet 33 each has a thread 312 and 332, respectively to connect to the cold and hot water pipes. Other connecting means may be used rather than a threaded pipe, for example a snap-on connection.

Water is supplied through the water outlet 35.

Optionally, an electricity generator 356 may be mounted at the water outlet 35 or in another location in the faucet, to convert water flow energy into electrical energy. The energy thus generated is used at the faucet to supply it with electrical energy. The energy thus generated may be used to charge secondary batteries there, which are the source of the unit 42 and the other electronic means there.

Other energy generation means may be used, for example based on Peltier effect (hot/cold water temperature differential) or other type of generator.

Alternately, low voltage wiring within the walls may be used to supply each faucet with electrical energy. If such wiring is used, it may also be used to transfer info from the sensors, as well as various data and commands between the components of the system. A low voltage is preferable as it may not pose a danger to users, in case of malfunction.

In a preferred embodiment, the only temperature sensor being used is the sensor 452 at the output 35 of the faucet (at the water supply to user).

In a preferred embodiment, the valves 32 and 34 have a variable rate of flow, which may be controllable by the control unit through control signals. The output valve 36 is preferably of a ON/OFF type—it is turned OFF when the faucet is not used or during water circulation; it is turned ON to supply water to the user.

The valves 32, 34 are further detailed with reference to FIGS. 10-13; the valve 36 may be installed at the water outlet 35 of the unit in FIG. 10.

The valves 32, 34 may be implemented as two plungers working into the mixing chamber 366.

The valve unit may include one to three temperature sensors.

The valve unit may include various sensors, besides the temperature sensors. These sensors may include pressure, water flow rate, etc.

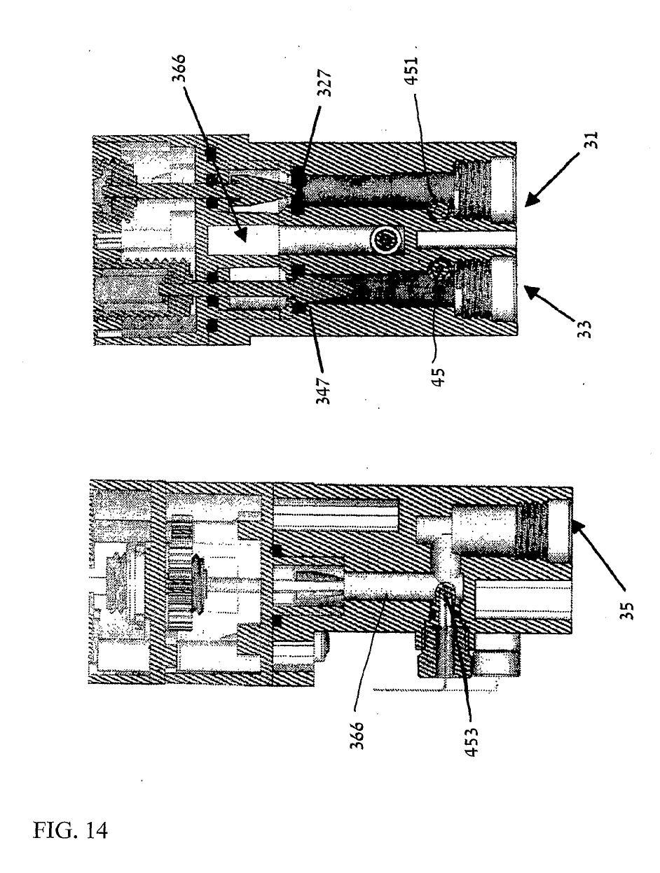

In a preferred embodiment, a micro valve unit includes the valves 32 and 34, for controlling the cold and hot water inflow, see FIGS. 10 and 14.

Preferably, the unit in FIGS. 10 and 14 does not include the valve 36, which is attached at the output of the unit there.

Preferably, the unit has a standard diameter, to fit in existing faucet infrastructure, for example a battery faucet, a wall-mount faucet or a deck-mounted faucet:

Option A: the diameter of the unit is about 35 mm (millimeters).
Option B: the diameter is about 25 mm
Option C: the diameter is about 20 mm
Option D: the diameter is in the range of about 25 to 35 mm
Option E: the diameter is in the range of about 15 to 25 mm
Other standard diameter values may be used.

FIG. 10 illustrates two cross-sectional longitudinal views of a preferred embodiment of the new micro valve, detailing the cold water inlet 31 and hot water inlet 33, and the water outlet 35.

The hot water valve 34 is shown in its fully closed state, and the cold water valve 32 is shown in its fully opened state.

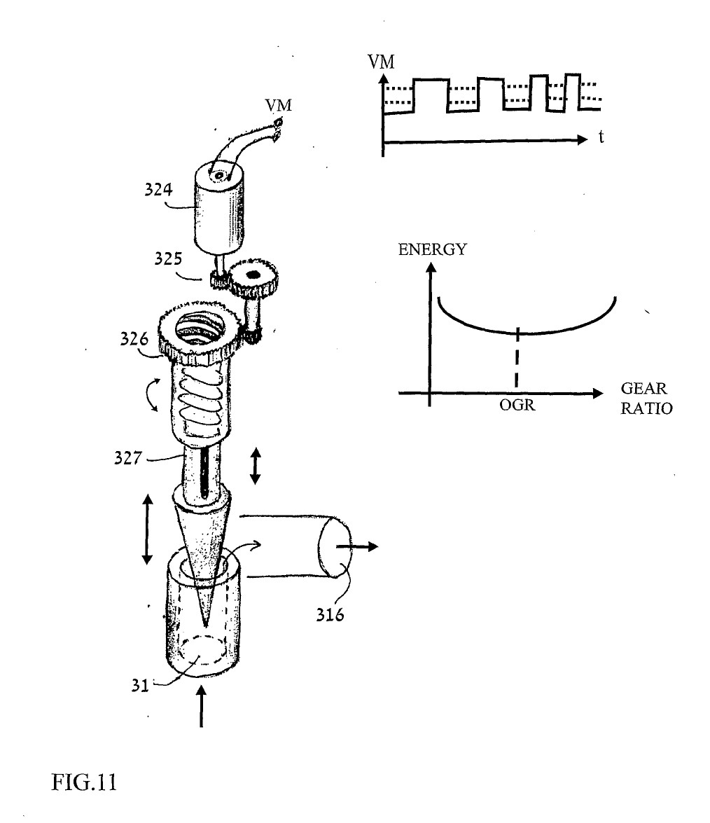

A temperature sensor 452 may be mounted at the output of the device. The device uses plunger means 327, 347 and electrical motors 324 and 344 with optional transmission means 325 and 345 to control the water flow, see also FIG. 11.

A novel feature of this structure is the use of plungers with a mixing chamber 366.

FIG. 11 details an exploded view of a valve structure. This valve may be used for example in the faucet structures of FIG. 9, 10 or 12.

The electrical motor 324 acts upon the transmission means (gear) 325 to rotate the part with inner thread 326. This rotation causes the plunger 327 to move up (to open the valve) or down (to close it).

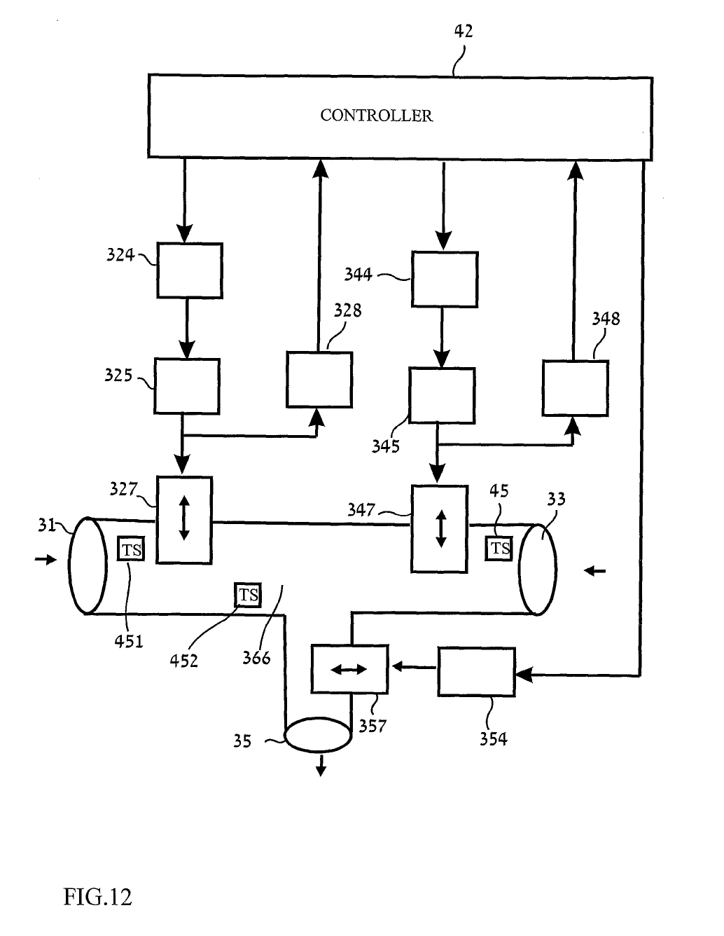

Also shown are the cold water inlet 31 (in this example; the same structure may be implemented for the hot water), and the valve outlet 316 toward the mixing chamber 366, see FIG. 12.

The electrical motor 324 may be pulse activated as illustrated with the graph of Vm vs. time. The duty cycle of the voltage may change. The polarity may be reversed to reverse the direction of movement. In another embodiment, a stepper motor may be used.

The gear ratio of the gear between motor 324 and plunger 327 may be so devised as to minimise the mechanical energy required to move the plunger 327. As illustrated in the graph there, there may be an optimal gear ratio (OGR) for maximal performance, where there is optimal matching between the impedance of the source and the load, also taking into account the water pressure in inlet 31.

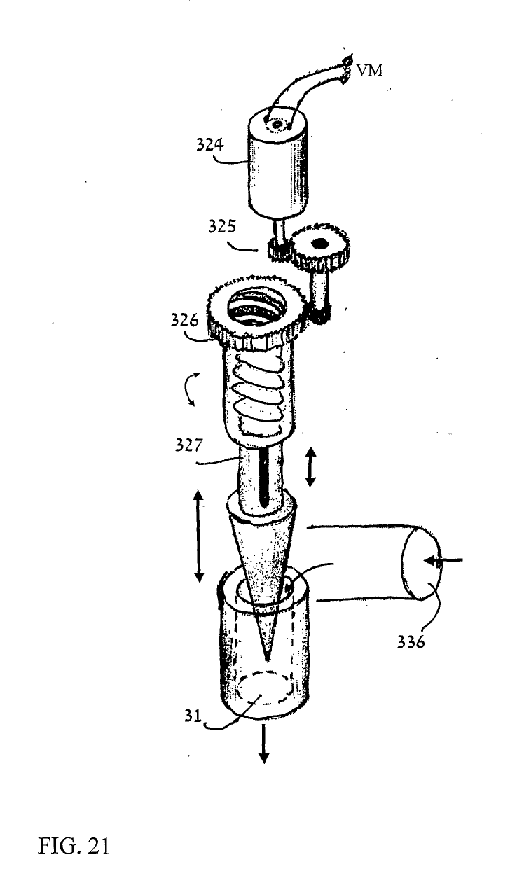

A possible problem with this embodiment is the water pressure in inlet 31, which opposes a down movement of plunger 327, thus causing a waste of energy. A possible solution may be a loaded spring to always push the plunger 327 down, to counter the force of the water pressure; the motor 324 then only has to provide the differential force (a lower value force) to move the plunger 327 up or down. Another solution is illustrated in FIG. 21, which details an embodiment wherein the water flows in the opposite direction, from 316 toward 31; in this case, water pressure will not oppose the closing of the valve.

FIG. 12 illustrates a functional cross-sectional view of a preferred embodiment of the new micro valve, detailing the cold water inlet 31 and hot water inlet 33, and the water outlet 35.

In one embodiment, there are the temperature sensors (TS) located as illustrated: TS 451 near the cold water inlet 31, TS 452 in the mixing chamber 366 and TS 45 located near the hot water inlet 33. The sensors are connected to the controller 42. In another embodiment, only the sensor 452 is used.

The electrical motor 324 acts upon the optional transmission means (gear) 325 to move the plunger 327 which controls the cold water supply from the cold water inlet 31.

Similarly, the electrical motor 344 acts upon the optional transmission means 345 to move the plunger 347 which controls the hot water supply from the hot water inlet 33.

Water from the hot and cold inlets will mix in the mixing chamber 366, the result being water at the desired temperature which flows out outlet 35.

Flow to the outlet 35 is controlled by means 357 comprising water flow control means as known in the art. The means 357 is moved by the actuator means 354. In a preferred embodiment, means 357 has only two positions, ON or OFF. A suitable embodiment for the actuator 354 may be an electrical solenoid. A possible ON/OFF valve may use a membrane valve.

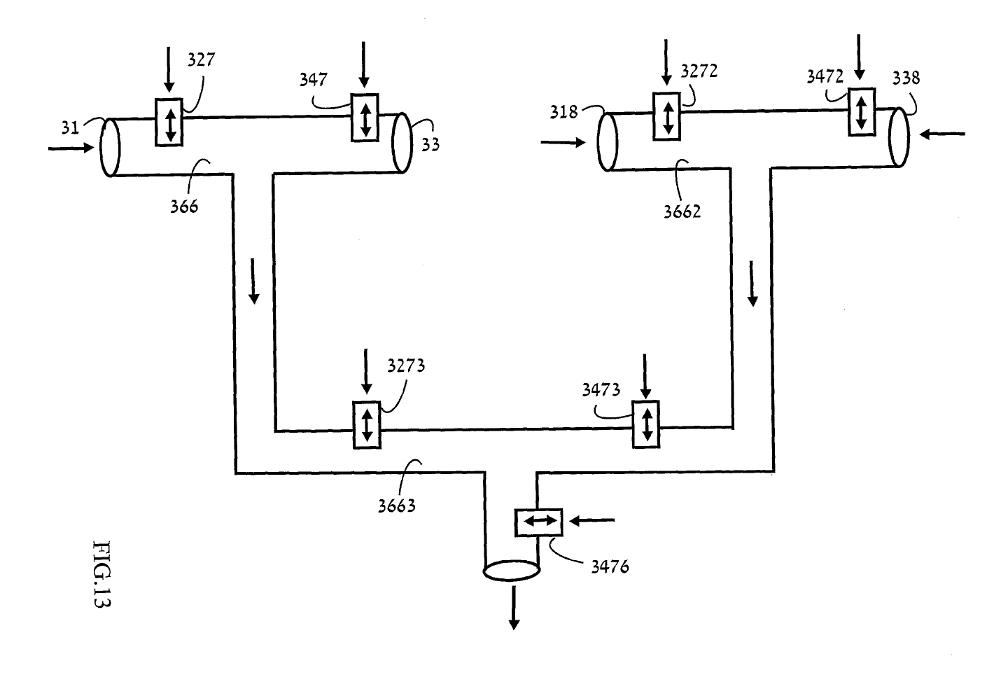

FIG. 13 illustrates a functional cross-sectional view of a device for mixing fluids from a plurality of sources. For example, people may desire to use either potable water or sea water, then to mix hot and cold water.

In this embodiment, hot water may use a fast heater on the pipe, such as that manufactured by Atmor(tm). The device may also find applications in mixing liquids in industry, or to mix gases.

For example, a sea water (cold) inlet 318 and (hot) inlet 338, with plungers 3272 and 3472 controlling the inflow of fluids to mixing chamber 3662; a third unit with plungers 3273 and 3473, with the fluids being mixed in mixing chamber 3663.

The output flow may be controlled with the plunger 3476 at the outlet of the device, as illustrated.

The device in FIG. 13 is stackable; more units may be used to allow a multitude of liquids and/or gases to be mixed in a plurality of mixing chambers along a processing path.

FIG. 14 illustrates two cross-sectional longitudinal views of yet another embodiment of the new micro valve detailing the cold water inlet 31 and hot water inlet 33.

Also illustrated is the mixing chamber 366, where hot water is mixed with cold water when water is supplied to the user through the water outlet 35.

In this figure, the hot water valve plunger 347 is shown in its fully closed state, and the cold water valve plunger 327 is shown in its fully opened state. Also illustrated are the temperature sensors 45, 451, 453 for the hot and cold water inlets, and the mixing chamber respectively.

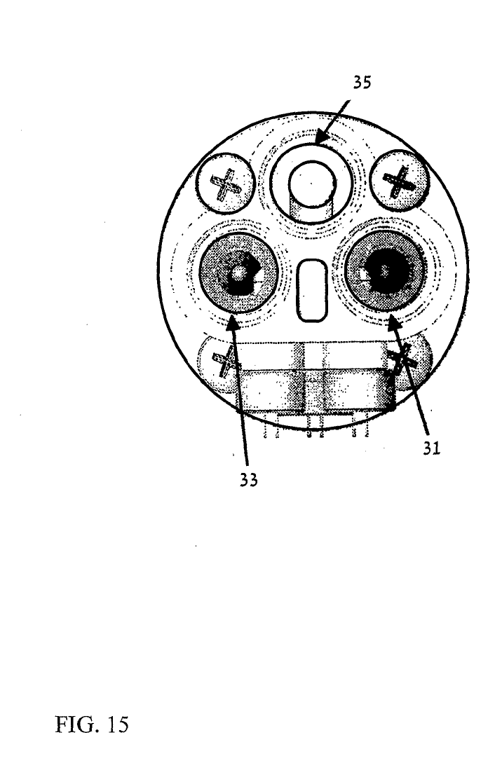

FIG. 15 illustrates a bottom view of the faucet, illustrating the cold water inlet 31, the hot water inlet 33 and the water outlet 35.

### 4. Human-Machine Interface

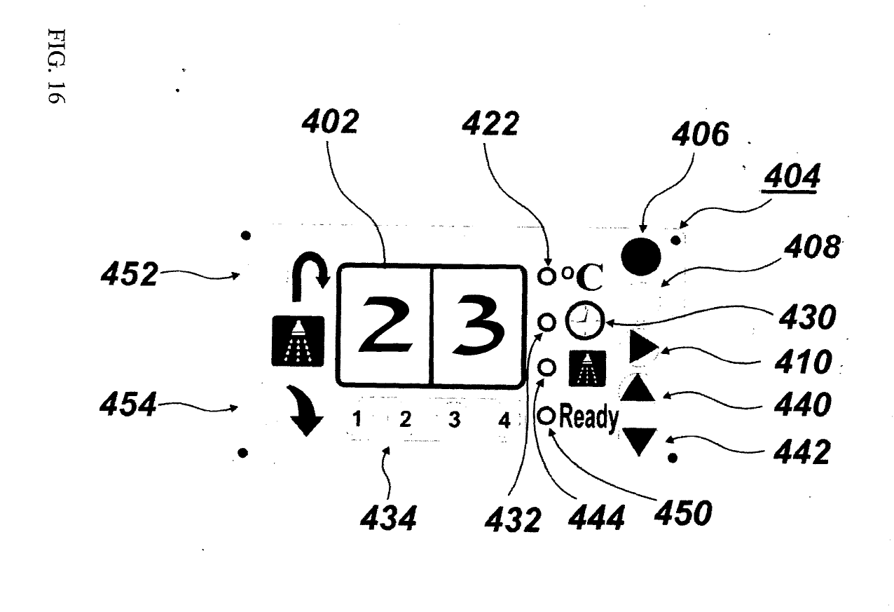

FIG. 16 illustrates one embodiment of a human-machine interface, more specifically a control and display panel usable for the unit 42 for controlling a hot/cold water tap or faucet.

The panel may include a temperature readout 402, and hot and cold water selection buttons 406 and 408.

If cold water is desired, pressing button 406 opens the cold water inlet valve. If hot water is desired, pressing button 408 will activate the cycling mechanism followed by the water delivery mechanism as detailed elsewhere in the present disclosure.

The temperature of hot water may be set using the function selection mechanism 410 and optional buttons.

Optional buttons may include:
A function selection mechanism 410 for selecting between different functions such as “temperature”, “time”, “flow”, etc. Each function selected may be indicated by appropriate indicators: 422, 432, 444 respectively.
“Up” and “Down” buttons 440 and 442 used for changing up and down (setting) the value of a chosen function.
A timer 430 for setting a desired water use time, a “time” indicator 432, memory means 434 for storing set temperatures and/or times, and outlet selection buttons 452 and 454 for selecting one of two outlets.

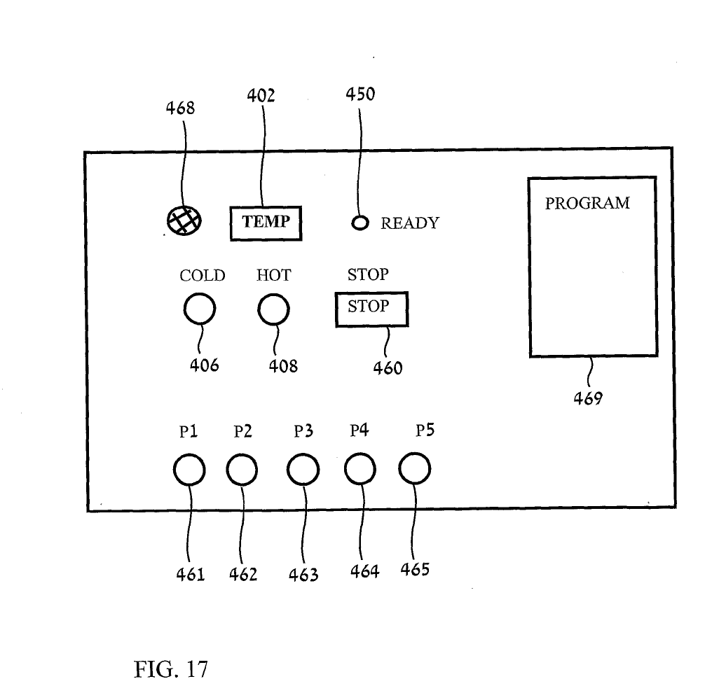

FIG. 17 illustrates another embodiment of the control panel.

The panel includes a temperature readout 402, Ready indicator 450, hot water selection button 408 to supply water at a desired temperature, and cold water button 406 for selecting cold water.

A stop button 460 may be used to immediately stop the water flow if activated.

The programmed buttons 461, 462, 463, 464, 465, etc.—each will supply water with pre-programmed parameters including for example temperature, flow rate, time of operation (optional—if to shut up the faucet automatically), etc.

Thus, each user may program a button (or several buttons) with the programs they may use. The faucet is thus personalized for each user.

A programming area 469 includes various buttons to program the faucet, for immediate or delayed delivery.

The panel includes a temperature readout 402, Ready indicator 450, hot water selection button 408 to supply water at a desired temperature, and cold water

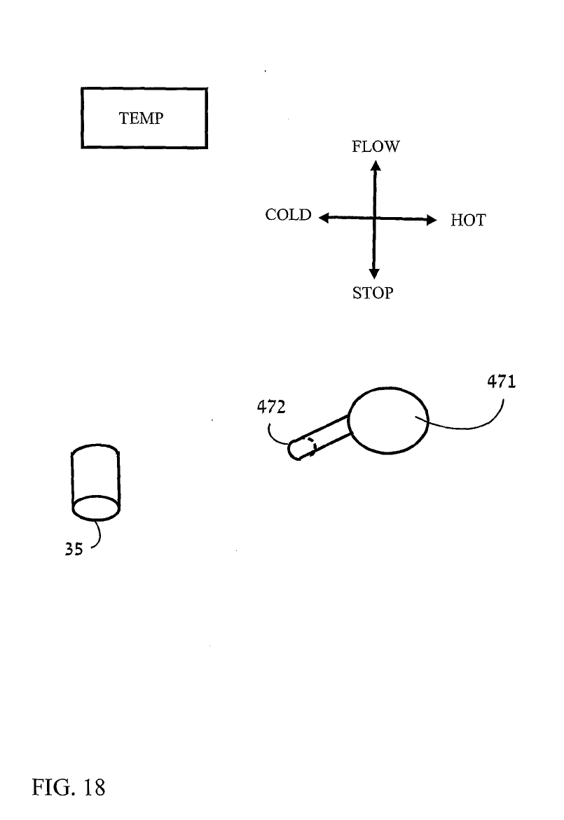

FIG. 18 illustrates yet another embodiment of the control panel, using a control lever 471 with a rotary joint 472.

Moving the lever Left-Right controls the temperature—more hot to the right.

Moving the lever Up-Down controls the water flow, from fully stopped (down) to full rate flow (up).

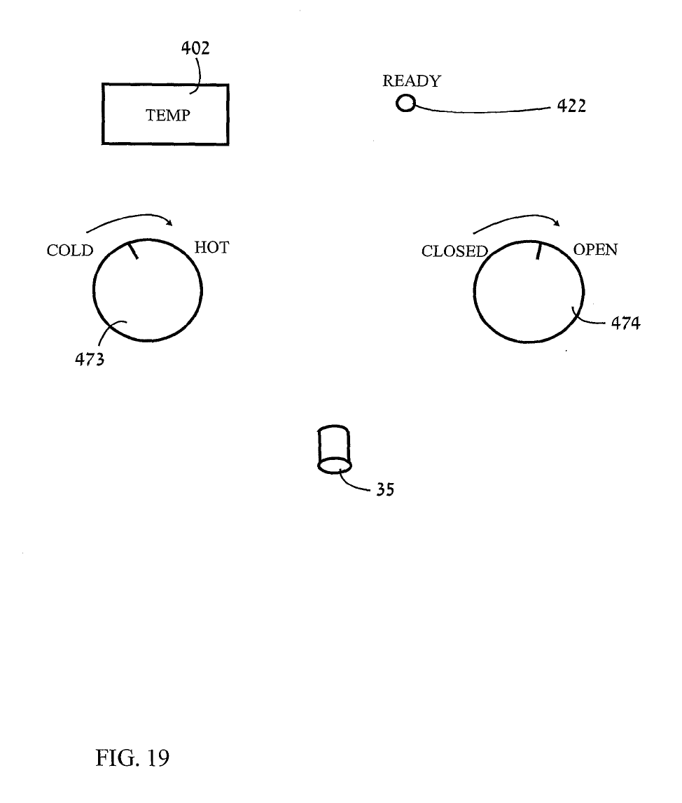

FIG. 19 illustrates yet another embodiment of the control panel, using two rotary controls: A temperature control knob 473 sets the temperature to a desired value; a flow control knob 474 controls the rate of flow of supplied water. Push buttons may be used to replace the knob 474.

### Method of Operation

a. the user selects a desired temperature using knob 473
b. the system activates water circulation, until hot water is ready at the faucet
c. the system sets the READY indicator 422, to signal that hot water is available.
d. When the flow knob 474 is rotated clockwise, water begins to flow.
The control input 474 may be a knob to be rotated, or push buttons to be pressed.
**End of method**
6. Protecting Users from Burns Due to Exposure to Hot Water

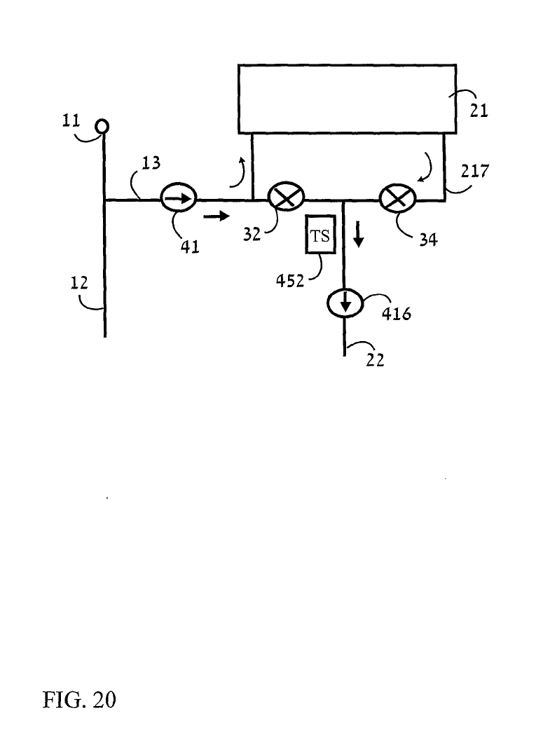

FIG. 20 illustrates a system for overall control of the temperature of the hot water supply to an apartment or house. New safety standards demand to limit the temperature of the hot water supply, to protect users from accidental burns if exposed to hot water only. The temperature of hot water supply should be limited to a predetermined value, for example 45 degrees Celsius.

The structure in FIG. 20 may be used to achieve compliance with such safety standards.

FIG. 20 illustrates a system for limiting the maximum temperature of hot water supplied to a house or apartment.

It is possible to limit the temperature of the water tank to, for example, 40 or 45 degrees Celsius; however, this results in much less hot water than a tank with water at 80 to 90 degrees Celsius. If the water are heated to a higher temperature, then the heat capacity is increased, more water may be used before the supply ends. (Of course the temperature may be reduced for economy reasons where less use is to be expected).

If the water in the tank are heated to a higher temperature, however, there is the danger of a user's injury, in case of exposure to hot water.

And, indeed, there are now safety standards which limit the maximum temperature of hot water supplied to an apartment, to prevent such dangers.

The novel approach taken in the present invention is to heat the water in the tank 21 to a higher temperature, to increase the heat capacity of the system. At the same time, limiting the maximum temperature of water supplied to the apartment by mixing with cold water, in such a proportion of hot/cold water as to ensure the temperature of hot water to the apartment is kept within safe margins.

As illustrated in FIG. 20, the valves 32 and 34 are electrically controlled. The valves 32 and 34 control the rate of flow of hold and hot water, respectively. The temperature of the water, preferably in a mixing chamber, is measured with temperature sensor 452.

The valves 32 and 34 are so controlled as to achieve a desired temperature at the output of the system in pipe 22. Pipe 22 is the hot water supply to the apartment.

Either a circulating pump 41 in the cold water, or a circulating pump 416 in the hot water, may be used.

7. Operating Panel with Advanced Display Means

A novel operating panel may include advanced display means, including for example VGA or video or television display for viewing TV or movies or other info while in the shower. For example, the program means 469 in FIG. 17 may include video display means such as a LCD device, having a dual use—both to control the hot/cold water supply, and to view a TV program, an alarm/monitoring camera, etc.

A multi-functional display may be used both to control the water supply and subsequently to present other information. The display may include a touch screen, to be also used for inputting data and/or commands. Preferably, the display should be resistant to water and vapors.

It will be recognized that the foregoing is but one example of an apparatus and method within the scope of the present invention and that various modifications will occur to those skilled in the art upon reading the disclosure set forth hereinbefore.

1. A system for supplying hot and cold water to an apartment/house, to all or part of the users therein, while recycling water from the hot water pipe into the cold water pipe, comprising:
a. at least one faucet means having adjustable first and second valves installed in paths to the hot and cold water inlets, respectively, and a third valve, an on/off valve, installed in a path to the faucet outlet, wherein the valves are electrically controlled;
b. a circulation pump installed in the cold water pipe such that, when the first and second valves of at least one faucet are open and the third valve is closed, activating the circulation pump will cause water from the hot water pipe to flow through the faucet to the cold water pipe;
c. controller means for activating the three valves and the circulation pump in one of two modes of operation: in a first, circulation, mode, where the circulation pump is activated and water circulation is accomplished by opening the first and second valves and closing the third valve; and in a second, water supply, mode, where the circulation pump is deactivated and all three valves are opened to supply water from the hot water inlet and/or cold water inlet to the faucet outlet; the circulation mode activated when a user requires water to be supplied from the faucet, and until hot water at a predetermined temperature reaches the faucet.

2. The system according to claim 1, wherein the circulation pump pushes water along a closed circuit comprising a water tank, a hot water supply pipe, first and second valves in the faucet, a cold water supply pipe, the circulation pump and back to the tank.

3. The system according to claim 1, wherein the controller is adapted to calculate a temperature gradient versus time, including using the rate of flow, to control the supply of water, to achieve a regulated supply of controlled temperature and flow rate.

4. The system according to claim 3, wherein the calculated temperature gradient versus time is used to control the activation of the circulation mode to stop circulation when nearing or reaching the desired temperature.

5. (canceled)

6. (canceled)

7. The system according to claim 1, wherein each controller means further includes means for communicating with other controller means in other faucet means to form a distributed control system, and wherein at least one of the controller means is connected to the circulation pump and to heater means in the water tank.

8. The system according to claim 1, wherein each faucet means is connected to a central controller means for controlling the valves in all the faucet means connected thereto, responsive to input commands from a user.

9. (canceled)

10. The system according to claim 1 wherein, in the water supply mode, the controller continuously measures the temperature of water supplied and controls the first and second valve to supply water at a desired temperature and flow rate, despite possible disturbances.

11. A method for supplying hot and cold water in a system for supplying hot and cold water to users in an apartment/house, the method comprising:
a. accepting a user's order to supply hot water;
b. activating water circulation in a faucet means having adjustable first and second valves installed in paths to the hot and cold water inlets, respectively, and a third valve, being an on/off valve installed in a path to the faucet outlet, wherein the valves are electrically controlled, and the system includes a circulation pump, by closing the third valve, opening the first and second valves, and activating the circulation pump;
c. stopping circulation by deactivating the circulation pump, when the temperature at faucet reaches a predetermined value;
d. starting supplying water at the faucet, to the user either when the predetermined value of the temperature is reached or after a prompt from the user, by opening the third valve;
e. continuing to supply water at the faucet, while controlling the supplied water parameters;
f. determining whether to stop the water supply, and if not, reverting to step (e);
g. stopping the water supply.

12. (canceled)

13. (canceled)

14. (canceled)

15. (canceled)

16. (canceled)

17. The method according to claim 11, wherein determining when to stop the water supply in step (f) comprises detecting when the hot water supply is expected to be depleted soon, then issuing a suitable indication to warn the user.

18. (canceled)

19. (canceled)

20. The method according to claim 11, wherein the step of stopping the water circulation comprises:
a. measuring the water temperature using a temperature sensor in the faucet; and if two temperature sensors are used in the faucet, one at the hot water inlet, the other at the cold water inlet, then their readings may be advantageously used to better measure the temperature;
b. computing t(exp), the expected time for water to reach the desired temperature;
c. determining if it is time to stop circulation, and if no, reverting to step (a); and
d. stopping the water circulation.

21. The method according to claim 20, wherein in step (b) uses a first order estimation: computing the temperature change over time, dT/dt=delta(Temperature)/delta(time).

22. The method according to claim 20, wherein in step (b) uses a higher derivative of the T=f(time) function.

23. The method according to claim 20, wherein step (c) is implemented by checking whether water at the faucet has reached the desired temperature; if positive, then it is time to stop the circulation.

24. The method according to 11, wherein step (c) is implemented by maintaining a parameter in the system, t(stop), which is the time required to stop the water circulation, taking into consideration the inertia of the mass flow of water and the response time of the circulation pump and the valves; and calculating an expected time, t(exp), which is the time remaining for the water to reach the desired temperature and which is based on a first or higher order derivative of the temperature function; in order to stop the circulation when t(stop) equals t(exp).

25. (canceled)

26. (canceled)

27. (canceled)

28. A micro valve system including three valves activated electronically of a faucet, wherein the valves comprise adjustable first and second valves installed in paths to the hot and cold water inlets, respectively, for controlling the rate of flow in their respective paths; and a third valve, an on/off valve, installed in a path to the faucet outlet, and the valves are electrically controlled and the micro valve system has a standard diameter for easy installation in a faucet system.

29. The system according to claim 28, wherein the first and second valves each includes a plunger working in a mixing chamber of the valve system.

30. The system according to claim 28, further including an electricity generator mounted at the water outlet or in another location in the faucet, to convert water flow energy into electrical energy.

31. The system according to claim 1, comprising a plurality of mixing chambers with fluid conduits between the chambers and valves controlling the rate of flow to each mixing chamber, for mixing fluids from a plurality of sources.
